(19) United States
(12) Patent Application Publication
(10) Pub. No.: US 2021/0279052 A1
(43) Pub. Date: Sep. 9, 2021

(54) DELTA IMAGE UPDATE

(71) Applicant: QUALCOMM Incorporated, San Diego, CA (US)

(72) Inventor: Anushka Mihir NABAR, Hyderabad (IN)

(21) Appl. No.: 16/813,138

(22) Filed: Mar. 9, 2020

(51) Int. Cl. G06F 8/658; G06F 9/50; G06F 9/30; G06F 11/14; G06F 21/57

(52) U.S. Cl. CPC G06F 8/658; G06F 9/5061; G06F 9/5016; G06F 21/572; G06F 11/1469; G06F 11/1417; G06F 9/30094

(57) ABSTRACT

In some aspects, the present disclosure provides a method for performing a software update. The method includes receiving, by a device, a delta image, the delta image comprising a metadata segment and one or more delta segments, wherein the one or more delta segments correspond to an update to one or more segments of a plurality of segments of a first image of a first software stored on a first memory partition, the metadata segment comprising: (i) for each of the one or more delta segments, an indication of a physical resource location in the first memory partition for storing the corresponding delta segment, and (ii) for each of the plurality of segments other than the one or more segments, an indication of a physical resource location in the first memory partition where the corresponding segment is stored.

### BACKGROUND

### Field of the Disclosure

The teachings of the present disclosure relate generally to software update operations, and more particularly, to techniques for reducing memory resources required for electronic device software updates.

### Description of the Related Art

Many electronic devices utilize low-cost and small-sized non-volatile storage for storing software. In some cases, devices may employ an AB partitioning scheme, wherein the device operates from software stored on a first partition, and wherein a second partition contains a back-up copy of the software so that the device can roll back to the back-up copy if an error occurs during or immediately after an update to the first partition.

However, many devices do not have the non-volatile storage capacity required for storing both the software and a duplicate version of the software for back-up. In these cases, updates can be applied directly to the software of the device without a back-up of the software. Problems with this approach arise however, if the update has functional issues and/or contains corrupted data because there is no back-up software on the device to roll back to. As such, updating electronic devices pose many challenges.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects provide for a method for performing a software update. In some examples, the method includes receiving, by a device, a delta image, the delta image comprising a metadata segment and one or more delta segments, wherein the one or more delta segments correspond to an update to one or more segments of a plurality of segments of a first image of a first software stored on a first memory partition, the metadata segment comprising: (i) for each of the one or more delta segments, an indication of a physical resource location in the first memory partition for storing the corresponding delta segment, and (ii) for each of the plurality of segments other than the one or more segments, an indication of a physical resource location in the first memory partition where the corresponding segment is stored. In some examples, the method includes storing the received delta image in a second memory partition. In some examples, the method includes booting the device by: determining whether to utilize the delta image for boot; based on determining to utilize the delta image for boot, loading into working memory each of the one or more delta segments; loading into the working memory each of the plurality of segments other than the one or more segments; attempting to boot the device; and when the device boots successfully, overwriting the one or more segments with the one or more delta segments in the first memory partition.

Certain aspects provide for an apparatus configured to performing a software update. In some examples, the apparatus comprises a memory; and a processor communicatively coupled to the memory. In some examples, the processor is configured to: receive a delta image, the delta image comprising a metadata segment and one or more delta segments, wherein the one or more delta segments correspond to an update to one or more segments of a plurality of segments of a first image of a first software stored on a first memory partition, the metadata segment comprising: (i) for each of the one or more delta segments, an indication of a physical resource location in the first memory partition for storing the corresponding delta segment, and (ii) for each of the plurality of segments other than the one or more segments, an indication of a physical resource location in the first memory partition where the corresponding segment is stored. In some examples, the processor is configured to store the received delta image in a second memory partition. In some examples, the processor is configured to boot the device, wherein the processor is further configured to: determine whether to utilize the delta image for boot; based on determining to utilize the delta image for boot, load into working memory each of the one or more delta segments; load into the working memory each of the plurality of segments other than the one or more segments; attempt to boot the device; and when the device boots successfully, overwrite the one or more segments with the one or more delta segments in the first memory partition.

Certain aspects provide an apparatus configured to performing a software update. In some examples, the apparatus includes means for receiving a delta image, the delta image comprising a metadata segment and one or more delta segments, wherein the one or more delta segments correspond to an update to one or more segments of a plurality of segments of a first image of a first software stored on a first memory partition, the metadata segment comprising: (i) for each of the one or more delta segments, an indication of a physical resource location in the first memory partition for storing the corresponding delta segment, and (ii) for each of the plurality of segments other than the one or more segments, an indication of a physical resource location in the first memory partition where the corresponding segment is stored. In some examples, the apparatus includes means for storing the received delta image in a second memory partition. In some examples, the apparatus includes means for booting the device, wherein the means for booting the device comprises: means for determining whether to utilize the delta image for boot; means for loading into working memory each of the one or more delta segments based on determining to utilize the delta image for boot; means for loading into the working memory each of the plurality of segments other than the one or more segments; means for attempting to boot the device; and means or overwriting the one or more segments with the one or more delta segments in the first memory partition when the device boots successfully.

Aspects of the present disclosure provide means for, apparatus, processors, and computer-readable mediums for performing techniques and methods for updating software on electronic devices.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an exemplary system-on-chip (SoC) integrated circuit in accordance with certain aspects of the present disclosure.

FIG. 2 is block diagram illustrating an example of a current software image, an updated software image, and a delta software image, in accordance with certain aspects of the present disclosure.

FIG. 3 is a block diagram illustrating an example metadata segment, and data associations within the metadata segment and elements of the delta software image, in accordance with certain aspects of the present disclosure.

FIG. 4 is a flow chart illustrating an example process for updating software according to aspects of the disclosure.

FIG. 5 is a flow chart illustrating example operations for updating software on a device according to aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with various other embodiments discussed herein.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects of the present disclosure. Such memory technologies/types include phase change memory (PRAM), dynamic random-access memory (DRAM), static random-access memory (SRAM), non-volatile random-access memory (NVRAM), flash memory (e.g., embedded multimedia card (eMMC) flash, flash erasable programmable read only memory (FEPROM)), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory.

Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language. Mobile computing device architectures have grown in complexity, and now commonly include multiple processor cores, SoCs, co-processors, functional modules including dedicated processors (e.g., communication modem chips, global positioning system (GPS) processors, display processors, etc.), complex memory systems, intricate electrical interconnections (e.g., buses and/or fabrics), and numerous other resources that execute complex and power intensive software applications (e.g., video streaming applications, etc.).

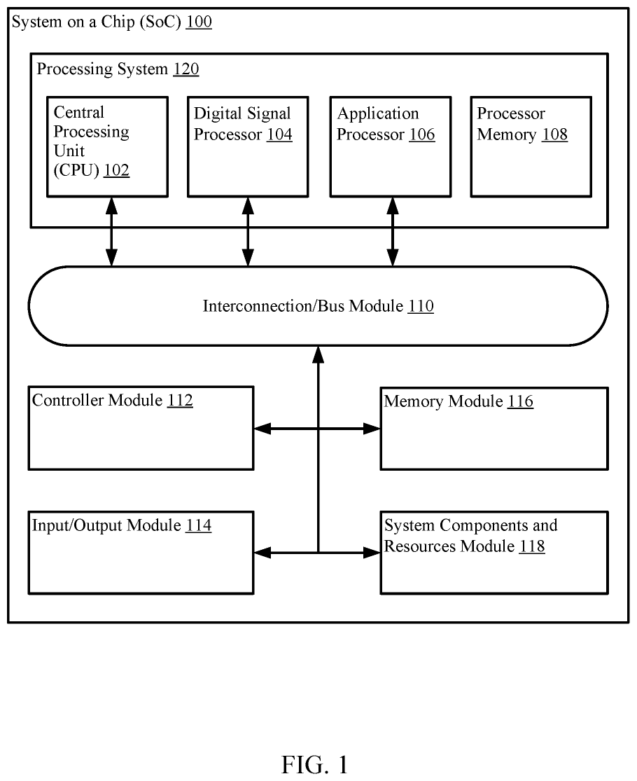

FIG. 1 is a block diagram illustrating an exemplary system-on-chip (SoC) 100 suitable for implementing various aspects of the present disclosure. The SoC 100 includes a processing system 120 that includes a plurality of heterogeneous processors such as a central processing unit (CPU) 102, a digital signal processor 104, an application processor 106, and a processor memory 108. The processing system 120 may include one or more cores, and each processor/core may perform operations independent of the other processors/cores. The processors 102, 104, and 106 may be organized in close proximity to one another (e.g., on a single substrate, die, integrated chip, etc.) so that they may operate at a much higher frequency/clock-rate than would be possible if the signals were to travel off-chip. The proximity of the cores may also allow for the sharing of on-chip memory and resources (e.g., voltage rail), as well as for more coordinated cooperation between cores.

The processing system 120 is interconnected with one or more controller module(s) 112, input/output (I/O) module(s) 114, memory module(s) 116, and system component and resources module(s) 118 via a bus module 110 which may include an array of reconfigurable logic gates and/or implement bus architecture (e.g., CoreConnect, advanced microcontroller bus architecture (AMBA), etc.). Bus module 110 communications may be provided by advanced interconnects, such as high performance networks on chip (NoCs). The interconnection/bus module 110 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In some cases, the bus module 110 may implement an arbitration scheme to prevent multiple master components from attempting to drive the bus simultaneously.

The controller module 112 may be a specialized hardware module configured to manage the flow of data to and from the memory module 116, the processor memory 108, or a memory device located off-chip (e.g., a flash memory device). In some examples, the memory module may include a host device configured to receive various memory commands from multiple masters, and address and communicate the memory commands to a memory device (e.g., universal flash storage (UFS), or other volatile/non-volatile memory devices). The multiple masters may include processors 102, 104, and 106, and/or multiple applications running on one or more of the processors 102, 104, and 106. The controller module 112 may comprise one or more processors configured to perform operations disclosed herein. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The I/O module 114 is configured for communicating with resources external to the SoC. For example, the I/O module 114 includes an input/output interface (e.g., a bus architecture or interconnect) or a hardware design for performing specific functions (e.g., a memory, a wireless device, and a digital signal processor). In some examples, the I/O module includes circuitry to interface with peripheral devices, such as a modem, memory device located off-chip, or other hardware communicatively connected to the SoC 100.

The memory module 116 is a computer-readable storage medium implemented in the SoC 100. The memory module 116 may provide volatile storage (e.g., RAM) and/or non-volatile storage (e.g., flash memory) for one or more of the processing system 120, controller module 112, I/O module 114, and/or the system components and resources module 118. The memory module 116 may include a cache memory to provide temporary storage of information to enhance processing speed of the SoC 100. In some examples, the memory module 116 may be implemented as a universal flash storage (UFS) integrated into the SoC 100, or an external UFS card.

The SoC 100 may include a system components and resources module 118 for managing sensor data, analog-to-digital conversions, wireless data transmissions, and for performing other specialized operations (e.g., supporting interoperability between different devices). System components and resources module 118 may also include components such as voltage regulators, oscillators, phase-locked loops, peripheral bridges, data controllers, system controllers, access ports, timers, and other similar components used to support the processors and software clients running on the computing device. The system components and resources 118 may also include circuitry for interfacing with peripheral devices, such as cameras, electronic displays, wireless communication devices, external memory chips, etc.

### Example Software Update

As noted previously, some devices may have a limited non-volatile storage capacity which prevents the device from being able to rely on AB partitioning or other similar methods for storing a back-up copy of software as well as to a copy of the same software that the device relies on for operation. Moreover, such devices may encounter issues with updates if the updates have functional (e.g., aspects that are incompatible with the device) or structural (e.g., data corruption of the update) problems. Such problems can cause a device to “brick” or become unresponsive to user commands.

Thus, aspects of the disclosure relate to methods of updating software on such devices that lack sufficient storage capacity, while also providing means for recovering from an update having functional or structural issues by rolling back to a previous version of the software.

For example, aspects of the disclosure relate to updating software via a delta image that includes only segments of software that are being updated. For example, if a device is operating on a software image stored in a non-volatile memory, an updated software image may be generated by a developer to update the device. However, in some examples, a delta image may be created based on the updated software image, wherein the delta image contains only segments of code that are different between the software image stored in the non-volatile memory and the updated software image. As such, the delta image may be a “lite” version of the updated software image.

In some examples, the non-volatile memory of the device may be partitioned into at least three separate partitions. A first partition may be configured to receive and store a delta image for updating software on the device. A second partition may include a multi-bit register configured to indicate whether a delta image is stored on the first partition and is available for updating the software image. In some examples, each bit in the multi-bit register may indicate a particular piece of software that the delta image corresponds to. For example, the delta image may include updates to one or more pieces of software. Thus, upon receipt of the delta image, the device may set one or more bits in the multi-bit register according to which software the delta image is configured to update. The software image may be stored in a third partition of the non-volatile memory.

Upon booting, the device may check the multi-bit register to determine whether an update is available. If the delta image is available, the device may transfer the delta image from the first partition to a working memory (e.g., volatile memory) location, along with any segments of the software image on the device that are not updated by the delta image. From there, the device may boot from the delta image segments and software segments in the working memory location, and clear the multi-bit register.

In this way, if the boot is unsuccessful, the working memory is cleared, and the device may boot from the software stored on the third partition. If the boot is successful, the delta image segments may be used to overwrite the corresponding segments of the software stored on the third partition.

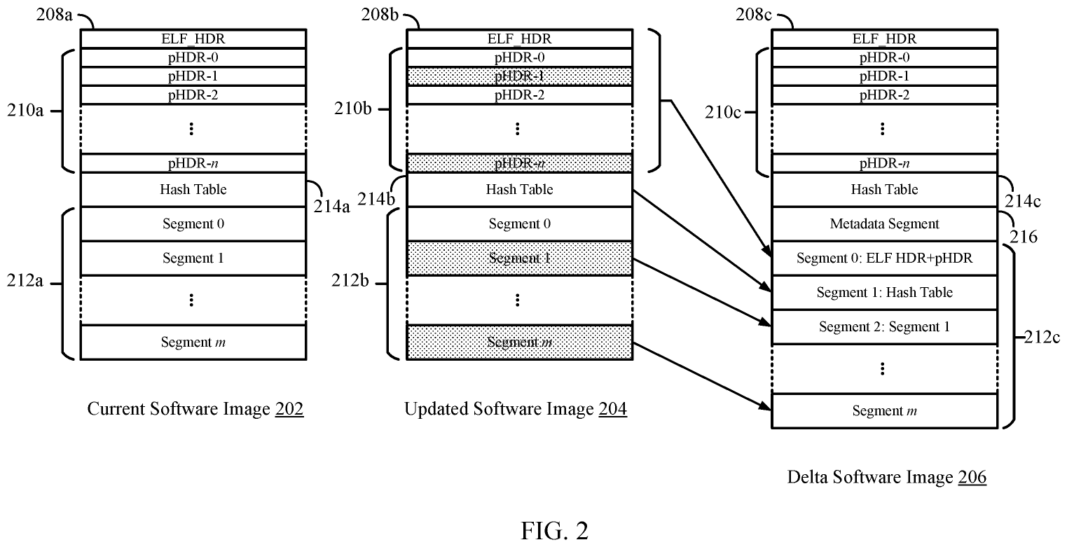

FIG. 2 is block diagram illustrating an example of a current image 202, an updated image 204, and a delta image 206, in accordance with certain aspects of the present disclosure. The current image 202 is a software image that is stored on a non-volatile memory of an electronic device, and is used to operate the device. The current image 202 may include an executable and linkable format (ELF) header 208a, a plurality of program headers (pHDRs) 210a, a hash table 214a, and a plurality of segments 212a.

The updated image 204 includes an executable and linkable format (ELF) header 208b, a plurality of pHDRs 210b, a hash table 214b, and a plurality of segments 212b. The updated image 204 is a software image is an updated version of the current image 202. Thus, the updated image 204 may include some of the same elements as the current image 202 with the exception of elements that have been updated relative to the current image 202. For example, the updated image 204 may include an updated pHDR−1 header and a pHDR-n header in the plurality of pHDRs 210b, and an updated Segment 1 and updated Segment m in the plurality of segments 212b.

The delta image 206 includes an executable and linkable format (ELF) header 208c, a plurality of pHDRs 210c, a hash table 214b, a metadata segment 216, and a plurality of segments 212c. The plurality of segments 212c of the delta image 206 may include only the updated segments of the updated image 204. For example, Segment 0 may include an updated ELF header (e.g., ELF header 208b) and/or pHDRs (e.g., pHDR−1 and pHDR-n of updated image 204), Segment 1 may include an updated hash table (e.g., hash table 214b of updated image 204), Segment 2 may include Segment 1 of updated image 204, and Segment m may include Segment m of updated image 204.

As shown in FIG. 2, the current image 202, updated image 204, and delta image 206 may be formatted in ELF. As such, each of the images may include an ELF header element (208a, 208b, 208c—collectively referred to as ELF header 208). The ELF header 208 may define address lengths and other information about other elements (e.g., pHDRs, hash tables, segments, etc.). Each of the images may also include one or more pHDRs (210a, 210b, 210c—collectively referred to as pHDR 210), configured to provide information regarding how the images are to be processed. For example, each pHDR 210 may correspond to a segment of the corresponding image.

The hash table (214a, 214b, 214c—collectively referred to as hash table 214) is a data structure configured to provide mapping between information in the ELF header 208, the pHDRs 210, and the plurality of segments 212 of each image.

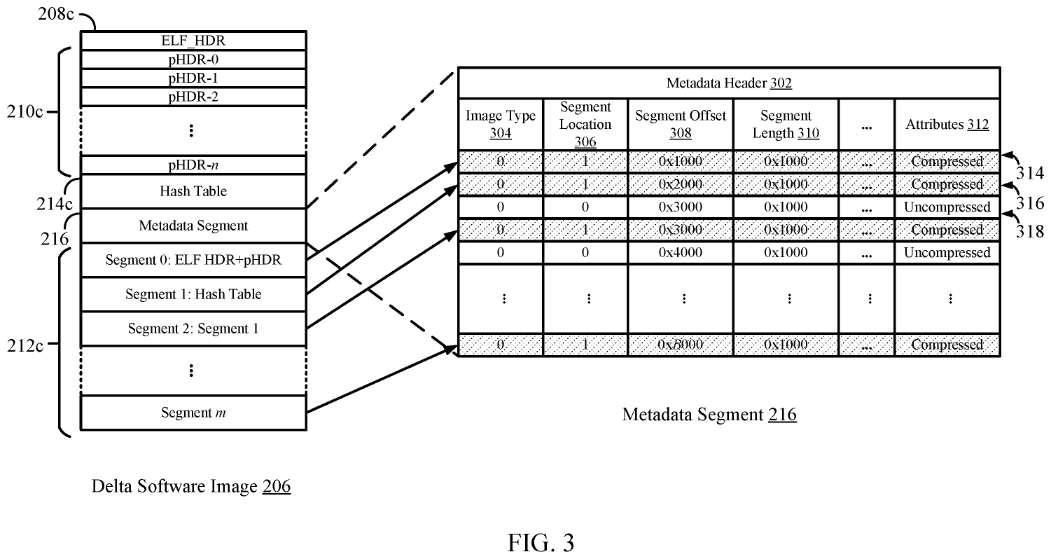

FIG. 3 is a block diagram illustrating an example metadata segment 216, and data associations within the metadata segment 216 and elements of the delta image 206, in accordance with certain aspects of the present disclosure. In the example shown, the metadata segment 216 may include a plurality of fields including at least a metadata header 302, followed by several rows. A first row includes a plurality of columns labeled according to the data within the corresponding column. In this example, the columns include an image type 304, a segment location 306, a segment offset 308, a segment length 310, and attributes 312. Each of the subsequent rows may correspond to a particular segment of the current software image 202 and/or an element of the delta image 206.

In some examples, the metadata header 302 may include one or more of an indication of a version of the delta image 206, a number of entries in the metadata segment (e.g., a number of rows under the plurality of fields), a size of the metadata header 302 (e.g., a number or columns, data sizes of entries under each column, etc.).

The image type 304 field may include one or more bits configured to indicate an aspect or service of the software that a particular segment belongs to. For example, an image type with a value “0” may indicate that the corresponding segment is an application type image segment, whereas an image type with a value of “1” may indicate that the corresponding segment 212c is a modem type image segment. Accordingly, if the delta software image includes an update to multiple aspects/services of the software, these aspects can be identified under the image type field.

The segment location 306 field may indicate which of the delta image 206 or the current image 202 a segment in each row corresponds to. For example, the segment location 306 of a first row 314 and a second row 316 have a one bit value of “1” indicating that the first row 314 and second row 316 each correspond to a segment of the delta image 206. The segment in the third row 318 has a one bit value of “0” indicating that the third row 318 corresponds to a segment of the current image 202. In some examples, the segment location 306 field indicates which portions of the current image 202 will remain unchanged. For example, the indication of a segment in the current image 202 within the metadata segment 216 indicates that the corresponding segment in the current image 202 will be preserved.

The segment offset 308 field may indicate where a particular segment of the current image 202 starts in the non-volatile memory (e.g., memory module 116), and where in the non-volatile memory a particular segment of the delta image 206 should be stored. For example, as shown in FIG. 3, the first row 314 and second row 316 each correspond to a segment of the delta image 206, and provide a location in the non-volatile memory where the segments are to be stored. In some examples, the segment offset location is a location relative to the location of the start of the ELF header (e.g., ELF HDR 208a in the current image 202).

The segment length 310 field may indicate a length of a particular segment (e.g., a length in bits). The attributes 312 field may include an indication of whether the segment is compressed or uncompressed. For example, segments of the delta image 206 may be compressed, whereas segments of the current image 202 may be uncompressed.

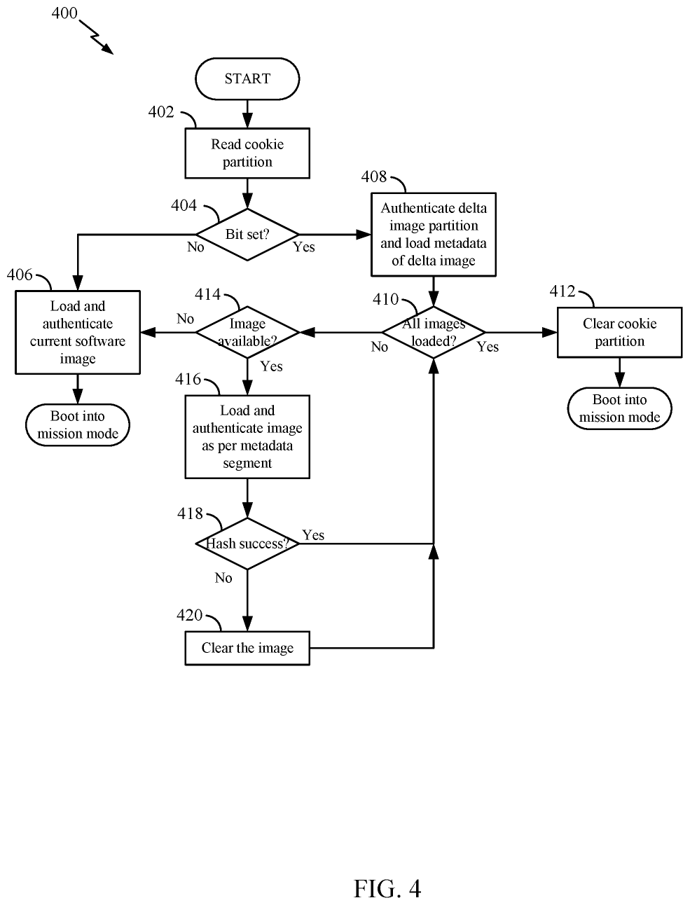

FIG. 4 is a flow chart illustrating an example process 400 for updating software according to aspects of the disclosure. The process 400 may be performed, for example, by a memory controller (e.g., such as the controller module 112 of the SoC 100 in FIG. 1). Process 400 may be implemented as software components that are executed and run on one or more processors (e.g., processing system 120 of FIG. 1). In certain aspects, the transmission and/or reception of data by various hardware components may be implemented via a bus interface (e.g., bus module 110 of FIG. 1).

As discussed, a non-volatile memory of a device (e.g., SoC 100 of FIG. 1) may include a first partition and a second partition. The first partition may contain data configured to indicate whether the second partition contains a delta image (e.g., delta image 206 of FIGS. 2 and 3). For example, the device may be configured to receive for over-the-air (OTA) software updates. Such software updates may communicate the delta image 206 to the device, which then stores the delta image 206 to the second partition, and updates the first partition to indicate the presence of the delta image 206.

In a first step 402, the device may read the first partition to determine whether the second partition contains the delta image 206 (e.g., a software update), and in some examples, what software on the device 100 the delta image 206 corresponds to. In some examples, the device may read the first partition upon power on, or boot of the device 100.

In a second step 404, the device 100 determines whether the data in the first partition indicates that the second partition contains the delta image 206. As discussed, the indication may be one or more bits set in a multi-bit register.

If there is no bit set in the first partition, then the process may advance to a third step 406, wherein the device loads and authenticates the current software image (e.g., current image 202 of FIG. 2) before proceeding to mission mode, where in the current software image is loaded and used as the basis for booting.

If there is at least one bit set in the first partition, then the process may advance to a fourth step 408. In this step, the device 100 may authenticate the delta image 206 to confirm whether the delta image 206 is corrupted or whether the hash (e.g., hash table 214c of FIG. 2) of the delta image 206 can be authenticated. Once the delta image 206 is authenticated, the device 100 may load the delta image 206 into the working memory (e.g., RAM).

Once the delta image 206 is loaded into the working memory, the device, in a fifth step 410, may determine whether all images from the second partition have been authenticated and/or loaded. As discussed earlier, the data in the first partition may indicate that multiple delta images are available for updating software on the device. As such, each image may be authenticated and loaded to the working memory. For example, if all of the images have been loaded or have at least been subject to an authentication process, the device 100 may proceed to a sixth step 412, whereby the device clears the first partition.

If, however, not all of the images have been loaded or at least subject to an authentication process, the device 100 may determine whether another image is available in the second partition at a seventh step 414. For example, data in the first partition may incorrectly indicate that the second partition has one or more delta images. In such a case, the process may advance to the third step 406, wherein the current image 202 is loaded. If, however, the device 100 determines at the seventh step 414 that the image is available from the second partition, the process may advance to an eighth step 416. At the eighth step 416, the device 100 may authenticate and load the delta image in the same manner as described in the fourth step 408. After successful authentication via a hash verification at a ninth step 418.

At a tenth step 420, if any image in the second partition cannot be successfully authenticated, then the device 100 may clear the delta image from the second partition.

Once one or more delta images are loaded into the working memory, the device 100 may also load segments of the current image 202 that are identified by the metadata segment 216 of the delta image 206 into the working memory. As such, the device 100 may attempt to boot off the segments in the working memory. If there is an error in the boot process, then the device 100 may restart (which clears the working memory) and load the current image 202 instead of any delta images. Accordingly, if the update is not functionally compatible with the device 100, the device 100 may simply reboot from its original software. In this way, the working memory can be utilized as a test memory to determine whether updates to the device will work prior to overwriting the device software with the updates.

If the device 100 is able to boot off the delta image segments in the working memory, the device 100 may overwrite portions of the current image 202 stored on the device 100 with the delta image 206 segments, thereby updating the software on the device.

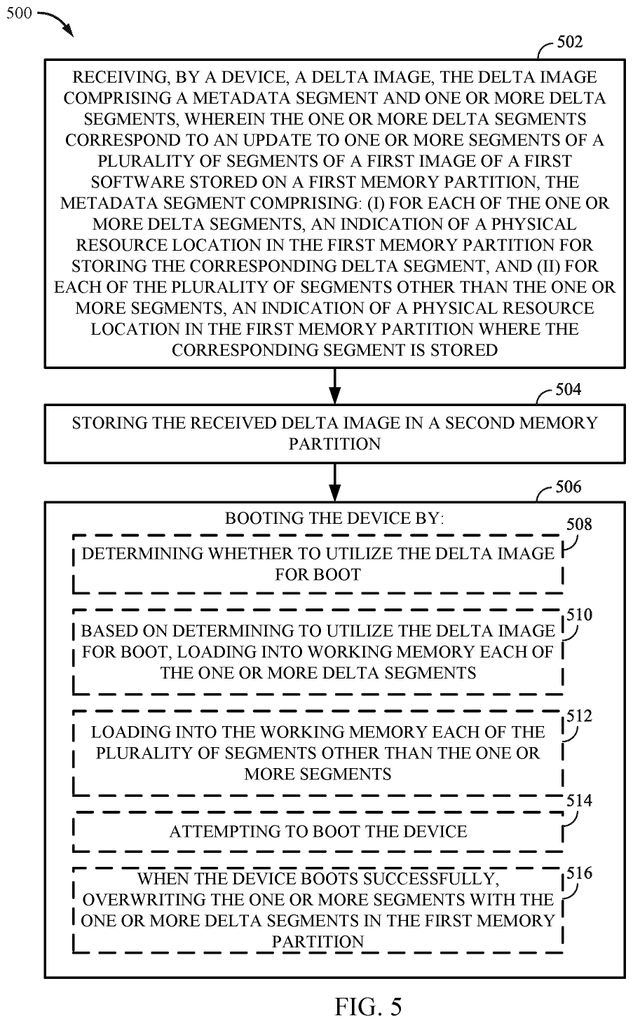

FIG. 5 is a flow chart illustrating example operations 500 for updating software on a device (e.g., SoC 100 of FIG. 1). The operations 500 may be performed, for example, by a memory 116 (e.g., such as the memory module 116 of the SoC 100). Operations 500 may be implemented as software components that are executed and run on one or more processors (e.g., processing system 120 of FIG. 1). In certain aspects, the transmission and/or reception of data by various hardware components may be implemented via a bus interface (e.g., bus module 110 of FIG. 1).

In this example, the operations 500 start at a first step 502 by receiving, by a device, a delta image, the delta image comprising a metadata segment and one or more delta segments, wherein the one or more delta segments correspond to an update to one or more segments of a plurality of segments of a first image of a first software stored on a first memory partition, the metadata segment comprising: (i) for each of the one or more delta segments, an indication of a physical resource location in the first memory partition for storing the corresponding delta segment, and (ii) for each of the plurality of segments other than the one or more segments, an indication of a physical resource location in the first memory partition where the corresponding segment is stored.

The operations 500 may then proceed to step 504 by storing the received delta image in a second memory partition.

The operations 500 may then proceed to step 506 by booting the device. In some examples, the device is booted according to a series of sub steps. In a first substep 508, the process 500 includes determining whether to utilize the delta image for boot. In a second substep 510, the process 500 includes, based on determining to utilize the delta image for boot, and loading into working memory each of the one or more delta segments. In a third sub step 512, the process 500 includes loading into the working memory each of the plurality of segments other than the one or more segments. In a fourth sub step 514, the process 500 includes attempting to boot the device. In a fifth substep 516, the process 500 includes, when the device boots successfully, overwriting the one or more segments with the one or more delta segments in the first memory partition.

In certain aspects, the operations 500 include, when the device boots unsuccessfully, attempting to boot the device again using all of the plurality of segments of the first image.

In certain aspects, determining whether to utilize the delta image for boot comprises determining a flag is set, the set flag configured to indicate the one or more delta segments are stored in the second memory partition.

In certain aspects, the set flag is further configured to identify the first image of the first software.

In certain aspects, the process 500 further includes setting the flag upon receiving the delta image; and clearing the flag prior to the attempt to boot the device.

In certain aspects, determining whether to utilize the delta image for boot further comprises: authenticating each of the one or more delta segments; and based on a determination that one or more of the one or more delta segments cannot be authenticated, determining not to utilize the one or more delta segments.

In certain aspects, authenticating each of the one or more delta segments comprises performing a hash check on each of the one or more delta segments.

In certain aspects, the metadata segment further comprises, for each of the one or more delta segments: an indication of the type of the first image; and an indication of a length of each of the one or more delta segments.

In certain aspects, each of the one or more delta segments is a compressed segment of the delta image, and wherein the one or more segments of the plurality of segments of the first image are not compressed.

Additional Considerations

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for” or simply as a “block” illustrated in a figure.

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise. The software may be stored on non-transitory computer-readable medium included in the processing system.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A method for performing a software update, comprising:
receiving, by a device, a delta image, the delta image comprising a metadata segment and one or more delta segments, wherein the one or more delta segments correspond to an update to one or more segments of a plurality of segments of a first image of a first software stored on a first memory partition, the metadata segment comprising: (i) for each of the one or more delta segments, an indication of a physical resource location in the first memory partition for storing the corresponding delta segment, and (ii) for each of the plurality of segments other than the one or more segments, an indication of a physical resource location in the first memory partition where the corresponding segment is stored;
storing the received delta image in a second memory partition;
booting the device by:
determining whether to utilize the delta image for boot;
based on determining to utilize the delta image for boot, loading into working memory each of the one or more delta segments;
loading into the working memory each of the plurality of segments other than the one or more segments;
attempting to boot the device; and
when the device boots successfully, overwriting the one or more segments with the one or more delta segments in the first memory partition.

2. The method of claim 1, further comprising, when the device boots unsuccessfully, attempting to boot the device again using all of the plurality of segments of the first image.

3. The method of claim 1, wherein determining whether to utilize the delta image for boot comprises determining a flag is set, the set flag configured to indicate the one or more delta segments are stored in the second memory partition.

4. The method of claim 3, wherein the set flag is further configured to identify the first image of the first software.

5. The method of claim 3, further comprising:
setting the flag upon receiving the delta image; and
clearing the flag prior to the attempt to boot the device.

6. The method of claim 1, wherein determining whether to utilize the delta image for boot further comprises:
authenticating each of the one or more delta segments; and
based on a determination that one or more of the one or more delta segments cannot be authenticated, determining not to utilize the one or more delta segments.

7. The method of claim 6, wherein authenticating each of the one or more delta segments comprises performing a hash check on each of the one or more delta segments.

8. The method of claim 1, wherein the metadata segment further comprises, for each of the one or more delta segments:
an indication of a type of the first image; and
an indication of a length of each of the one or more delta segments.

9. The method of claim 1, wherein each of the one or more delta segments is a compressed segment of the delta image, and wherein the one or more segments of the plurality of segments of the first image are not compressed.

10. An apparatus configured to performing a software update, comprising:
a memory; and
a processor communicatively coupled to the memory, the processor configured to:
receive a delta image, the delta image comprising a metadata segment and one or more delta segments, wherein the one or more delta segments correspond to an update to one or more segments of a plurality of segments of a first image of a first software stored on a first memory partition, the metadata segment comprising: (i) for each of the one or more delta segments, an indication of a physical resource location in the first memory partition for storing the corresponding delta segment, and (ii) for each of the plurality of segments other than the one or more segments, an indication of a physical resource location in the first memory partition where the corresponding segment is stored;
store the received delta image in a second memory partition;
boot the apparatus, wherein the processor is further configured to:
determine whether to utilize the delta image for boot;
based on determining to utilize the delta image for boot, load into working memory each of the one or more delta segments;
load into the working memory each of the plurality of segments other than the one or more segments;
attempt to boot the apparatus; and
when the apparatus boots successfully, overwrite the one or more segments with the one or more delta segments in the first memory partition.

11. The apparatus of claim 10, wherein the processor is further configured to attempt to boot the apparatus again using all of the plurality of segments of the first image when the apparatus boots unsuccessfully.

12. The apparatus of claim 10, wherein the processor, being configured to determine whether to utilize the delta image for boot, is further configured to determine a flag is set, the set flag configured to indicate the one or more delta segments are stored in the second memory partition.

13. The apparatus of claim 12, wherein the set flag is further configured to identify the first image of the first software.

14. The apparatus of claim 12, wherein the processor is further configured to:
set the flag upon receiving the delta image; and
clear the flag prior to the attempt to boot the apparatus.

15. The apparatus of claim 10, wherein the processor, being configured to determine whether to utilize the delta image for boot, is further configured to:
authenticate each of the one or more delta segments; and
based on a determination that one or more of the one or more delta segments cannot be authenticated, determine not to utilize the one or more delta segments.

16. The apparatus of claim 15, wherein the processor, being configured to authenticate each of the one or more delta segments, is further configured to perform a hash check on each of the one or more delta segments.

17. The apparatus of claim 10, wherein the metadata segment further comprises, for each of the one or more delta segments:
an indication of a type of the first image; and
an indication of a length of each of the one or more delta segments.

18. The apparatus of claim 10, wherein each of the one or more delta segments is a compressed segment of the delta image, and wherein the one or more segments of the plurality of segments of the first image are not compressed.

19. An apparatus configured to performing a software update, comprising:
means for receiving a delta image, the delta image comprising a metadata segment and one or more delta segments, wherein the one or more delta segments correspond to an update to one or more segments of a plurality of segments of a first image of a first software stored on a first memory partition, the metadata segment comprising: (i) for each of the one or more delta segments, an indication of a physical resource location in the first memory partition for storing the corresponding delta segment, and (ii) for each of the plurality of segments other than the one or more segments, an indication of a physical resource location in the first memory partition where the corresponding segment is stored;
means for storing the received delta image in a second memory partition;
means for booting the apparatus, wherein the means for booting the apparatus comprises:
means for determining whether to utilize the delta image for boot;
means for loading into working memory each of the one or more delta segments based on determining to utilize the delta image for boot;
means for loading into the working memory each of the plurality of segments other than the one or more segments;
means for attempting to boot the apparatus; and
means or overwriting the one or more segments with the one or more delta segments in the first memory partition when the apparatus boots successfully.

20. The apparatus of claim 19, further comprising means for attempting to boot the apparatus again using all of the plurality of segments of the first image when the apparatus boots unsuccessfully.
